(19) United States
(12) Patent Application Publication
(10) Pub. No.: US 2017/0178012 A1
(43) Pub. Date: Jun. 22, 2017

(54) PRECACHING VIA INPUT METHOD TRAJECTORY PREDICTION

(71) Applicant: Microsoft Technology Licensing, LLC, Redmond, WA (US)

(72) Inventors: Paul Valentin Borza, Redmond, WA (US); Vaibhav Parikh, Bothell, WA (US); Ovidiu Dan, Kirkland, WA (US); Kumar Srinivasamurthy, Bellevue, WA (US)

(73) Assignee: Microsoft Technology Licensing, LLC, Redmond, WA (US)

(21) Appl. No.: 14/973,087

(22) Filed: Dec. 17, 2015

(51) Int. Cl. G06N 7/00; G06N 99/00; G06F 17/30

(52) U.S. Cl. CPC G06N 7/005; G06F 17/30902; G06N 99/005

(57) ABSTRACT

Architecture that processes preemptive events for an application that trigger based on user interaction movements of a specific input method (e.g., a mouse pointer) in a virtual document of the application. Machine learning is employed to predict and identify a target element the user will select in the virtual document. Thus, event triggering occurs before the user has physically performed the interaction. In response, a request that would normally be sent from the application when the user interacts with the target element(s), is prematurely cached in a system and processed to retrieve the results of the request so that when the target element is actually interacted with, the results are immediately transmitted to the user device for viewing. This saves time in the system by processing critical path operations before the user has interacted with the target element, and ultimately, produces an improved user experience with the application.

### BACKGROUND

It is known in the industry that there is a correlation between the web page load time and revenue of a vendor website. This indicates that improved performance not only makes users more engaged with the website, but also increases revenue. The “click” input method is deemed an important action users perform in order to interact with a web page on a desktop computer. Similarly, in handheld devices such as tablets and cellphones, the “touch” input method is an important action of users.

Current human-device interaction systems are designed to respond to events once user actions have been initiated against these events using the one or more of the various user interactive input methods such as when the user clicks on a virtual button to submit the data to the server. However, these conventional methods are not sufficient for optimized revenue streams.

### SUMMARY

The following presents a simplified summary in order to provide a basic understanding of some novel implementations described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture introduces the capability in systems of “preemptive events”, rather than events that only react to a certainty. The preemptive events are processed for an application and trigger based on user interaction movements of a specific input method (e.g., a mouse pointer) in a virtual document of the application. Machine learning is employed to predict and identify one or more target element(s) the user will likely select in the virtual document. Machine learning can operate from a minimum set of training data developed for users in general, but then over time, converge on specific user actions/behaviors when providing input method interactions. Thus, training continues for the given user to reach an optimum input method set of data as to interactive behavior assist in identifying and discarding elements on the view.

Thus, event triggering occurs before the user has physically performed the interaction. In response, a request that would normally be sent from the application when the user interacts with the target element(s) is cached in a system and processed to retrieve the results of the request so that when the target element in the document is actually interacted with, the results are immediately transmitted to the user device for viewing. This saves time in the system by processing critical path operations before the user has interacted with the target element, and ultimately, produces an improved user experience with the application.

The input methods include, but are not limited to, commonly known pointing devices and interaction techniques such as a mouse, a pen, tactile interactions such as touch, concurrent touches (multiple fingers), touch gestures such as swipes, air gestures (single or multiple hand movements and gesture), facial recognition movements, NUI (natural user interface) actions (for speech recognition, voice commands, etc.), and so on. Thus, the triggering of the event(s) associated with document target elements occur before the user has physically performed the desired user interactions.

Predicting the target element and event that will be interacted which enables a website, for example, to further reduce page load times by precaching requests, and results for those requests before the request is actually received. Page load time is measured as the time span from the time the user has initiated a request (e.g., by clicking on a link, or typing a query followed by pressing enter) to the time the browser has rendered the entire content of the page.

The architecture finds particular applicability to search engine websites where browser applications are employed to present multiple elements and to which a user may traverse the webpage to a specific target element (e.g., a new search string, other search results, other webpage links, etc.).

The architecture also has applicability to applications other than web browsers, such as for web-based office applications that include a word processor, spreadsheet, presentation application, scheduling applications, and so on. In these implementations, the target elements can be application functions such as printing a word processing document in another format, as predicted by user movement from one application button to a button that when selected automatically initiates the process and returns the new document, when the user actually engages the print button. More specifically, the trajectory of a mouse pointer from a Save button to a “Print as PDF” button can be predicted with the event triggered to perform the conversion in the background such that once the user engages the Save button, the document has already been converted to PDF and cached in the user device, awaiting the user to physically select the “Print as PDF” button, after which the PDF version is immediately presented to the user, rather than the user waiting for the printing process to complete as in conventional system operations.

The architecture can be implemented as a system, comprising: a movement component configured to compute movement characteristics of a virtual pointer in an application view of an application of a device, the movement characteristics of the virtual pointer computed from a first element in the application view; a prediction component configured to predict an intended target element based on machine learning as applied to the movement characteristics of the virtual pointer in virtual regions of the application view; and, a preemptive component configured to initiate preemptive events in response to identification of the target element and in anticipation of user interaction with the target element via the virtual pointer.

The architecture can be implemented as a method, comprising acts of: detecting access of a webpage via a browser application in a display of a device; tracking movement characteristics of a virtual pointer over elements of the webpage, the movement characteristics define at least a trajectory from a first element of the webpage; predicting a target element in a virtual region of the webpage using machine learning as applied to the movement characteristics, the target element on the trajectory of the virtual pointer; initiating a preemptive event in response to prediction of the target element, the preemptive event causes signaling of a backend system to precache a request anticipated from the browser application; performing a time-expensive operation of the backend system in response to precaching of the request; precaching results associated with the request in the backend system prior to receiving user interaction with the target element; and, presenting the results in the browser application when the request is received from the browser application.

The architecture can be implemented as an alternative method, comprising acts of: identifying movement characteristics of a virtual indicator relative to elements of a document of a web application, the movement characteristics identified from a first element to a target element of multiple possible target elements viewable in a display of a device; predicting the target element of the document using machine learning as applied to the movement characteristics; triggering a preemptive event in response to prediction of the target element; signaling a system component to precache a request anticipated from the application, the signaling in response to triggering of the preemptive event; performing a time-expensive operation of the system component in response to precaching of the request; precaching results data in the system component in anticipation of receiving the request from the web application; and, sending the results data to the application when the request is received from the application.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an alternative system in accordance with the disclosed architecture

FIG. 3 illustrates a diagram of target element prediction on a webpage in accordance with the disclosed architecture.

FIG. 4 illustrates a method in accordance with the disclosed architecture.

FIG. 5 illustrates an alternative method in accordance with the disclosed architecture.

FIG. 6 illustrates a block diagram of a computing system that executes precaching via input method trajectory prediction in accordance with the disclosed architecture.

### DETAILED DESCRIPTION

The “click” (the noise associated with a button press of a mouse button) is now interpreted to be the single most important action users perform in order to interact with elements (an “event”) on a virtual document (e.g., a webpage, or more generally, a web-based application document, etc.). Current human-computer interaction systems are designed to be reactive, that is, respond to such events (element interactions) once actions have been taken against these events such as when the user clicks on a virtual button element on the web document in the display of a computing device to submit data to a server, or presses a keyboard key to send key data, and so on.

The disclosed architecture processes preemptive events for an application that trigger based on user interaction movements of a specific input method (e.g., a mouse pointer) in a virtual document of the application. Machine learning and reasoning (MLR) can be employed to predict and identify a target element the user will select in the virtual document. Thus, event triggering occurs before the user has physically performed the interaction with the document element (e.g., a button, or link).

In response, a request that would normally be sent from the application when the user interacts with the target element is prematurely cached in a system and processed to retrieve the results of the request so that when the target element is actually interacted with, the results are immediately transmitted to the user device for viewing. This saves time in the system by processing critical path operations before the user has interacted with the target element, and ultimately, produces an improved user experience with the application.

The disclosed architecture can employ various MLR-based schemes for carrying out various aspects thereof. For example, a process for predicting the trajectory among elements can be facilitated via an automatic classifier system and process. A classifier is a function that maps an input attribute vector, x=(x₁, x₂, x₃, x₄, . . . , xₙ, where n is a positive integer), to a class label class(x). The classifier can also output a confidence that the input belongs to a class, that is, f(x)=confidence (class(x)). Such classification can employ a probabilistic and/or other statistical analysis (e.g., one factoring into the analysis utilities and costs) to prognose or infer an action that a user desires to be automatically performed.

As used herein, terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, for example, various forms of statistical regression, naïve Bayes, Bayesian networks, decision trees, neural networks, fuzzy logic models, and other statistical classification models representing different patterns of independence can be employed. Classification as used herein also is inclusive of methods used to assign rank and/or priority.

As will be readily appreciated from the subject specification, the subject architecture can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be employed to automatically learn and perform a number of functions according to predetermined criteria for target element determination.

The disclosed architecture enables reduced page load time of documents, and documents linked from other documents, such as a web landing paged provide interactive elements that when selected by the user cause presentation of a subsequent document and content. Page load time is measured as the time span from the time the user has initiated a request (e.g., by clicking on a link, or typing a query followed by pressing enter) to the time the entire content of the page has been rendered by the browser.

One example is a browser application employed with interacting with search engines. Browsers can enable a website to track the movements of a mouse pointer over its webpages. In one implementation of the disclosed architecture, tracking pointer movements characteristics can be achieved via an onmousemove event attached to the body HTML (hypertext markup language) tag as described in the HTML standard. This is described in detail herein. More broadly, the architecture can provide precaching via a pointer trajectory prediction service to any website that is hosted on a web server. Vendors subscribing to a common server architecture not only benefit from improved page load times, but also from reduced engineering costs on the vendor side.

The disclosed architecture is not restricted to websites and website precaching to optimize the critical path execution of a web request. In terms of desktop applications (e.g., Excel™, Outlook™, Visual Studio™, etc.) that run on an operating system such as Windows™, these applications typically switch between threads to perform various tasks. In the case of desktop applications, rather than the precaching of web requests, processor-switching contexts can be precached. More specifically, the registers of a given thread on the processor can be prefetched based on knowing in advance that this given thread will get to run. Thus, the time the thread runs, the processor registers are already placed and the thread is ready to go. This capability makes sense especially for wearable devices where resources are scarce.

The disclosed architecture employs machine learning algorithms to predict the target element (e.g., HTML) that will be interacted with by means of processing pointer X/Y coordinates (e.g., in JavaScript™). Other pointer movement characteristics can be tracked and computed, including the velocity of the pointer as the pointer moves on the display. Additionally, touch pressure points on touch-enabled devices can be used to predict preemptive swipe events before the user has lifted one or more fingers off the display. The notion of preemptive events applies not only to the HTML standard but also to operating systems such as the Windows™ operating system (as the concept of preemptive events is applicable across all desktop applications as well). Furthermore, the pre-caching/fetching of resources is enabled as well as backend processing techniques, once the preemptive events have been triggered. This enables the reduction of page load times once the actual event (e.g., a click) has been triggered, since the instruction in the cache is created by the preemptive event and the cache is typically accessed first.

The disclosed architecture is not limited to computing movement characteristics and predicting the pointer trajectory, but also finds applicability a user is scrolling using a mouse or swapping aggressively in a particular direction or trajectory. In these cases, the acceleration with which content needs to be downloaded can be optimized. In terms of acceleration for example, for less acceleration, the user is interested in the next immediate content in the direction of the trajectory. For average acceleration, the user is interested in the not necessarily the next immediate content, but in the body/middle section of the entire payload in the direction of the trajectory. For greater acceleration (where the user does not keep track of how many times the user has scrolled/swiped or moved the mouse), the user is interested in the bottom-most content in the direction of the movement. It can be the top-most content if the direction is pointing that way.

In the above cases, the pointer trajectory is considered in combination with acceleration and force to precache the right content. Based on this, the content that needs to be cached can be predicted or cancellation of non-required payload requests can be made.

Furthermore, caching and/or prefetching need not be restricted within one application canvas. Caching can be made broader beyond the current application canvas to all active loaded applications. Interactions on one application can help prefetch content for next active application under interaction. Consider that application interaction ghosting of content in one application helps prefetch content for other applications. An application simply needs to be listening for such signals, and other applications need to enable broadcasting of these interaction and content signals.

Additionally, consider that given the existence of historical data on how the application was used in the past, the disclosed architecture can be used to predict which resources to prefetch based on past user actions. For example, assume the application is a web browser and there exists historical data for each address inserted into the browser address bar. When a user visits http://www.ABC.com/, based on the aggregate historical data obtained about other users visiting the same website, it is known on average which links inside the “ABC” website are more likely to be clicked; hence, those pages can be prefetched before the current user click.

User interaction with a device, a client application, a user interface, etc., can be gesture-enabled, whereby the user employs one or more gestures for interaction. For example, the gestures can be natural user interface (NUI) gestures. NUI may be defined as any interface technology that enables a user to interact with a device in a “natural” manner, free from artificial constraints imposed by input devices such as mice, keyboards, remote controls, and the like. Examples of NUI methods include those methods that employ gestures, broadly defined herein to include, but not limited to, tactile and non-tactile interfaces such as speech recognition, touch recognition, facial recognition, stylus recognition, air gestures (e.g., hand poses and movements and other body/appendage motions/poses), head and eye tracking, voice and speech utterances, and machine learning related at least to vision, speech, voice, pose, and touch data, for example.

NUI technologies include, but are not limited to, touch sensitive displays, voice and speech recognition, intention and goal understanding, motion gesture detection using depth cameras (e.g., stereoscopic camera systems, infrared camera systems, color camera systems, and combinations thereof), motion gesture detection using accelerometers/gyroscopes, facial recognition, 3D displays, head, eye, and gaze tracking, immersive augmented reality and virtual reality systems, all of which provide a more natural user interface, as well as technologies for sensing brain activity using electric field sensing electrodes (e.g., electro-encephalograph (EEG)) and other neuro-biofeedback methods.

The disclosed architecture exhibits technical effects rooted in computer technology to overcome problems specifically occurring in the realm of computer systems and networks. More specifically, the architecture enables time conservation in the system by processing critical path operations before the user has interacted with a target element, and ultimately, produces an improved user experience with the application.

The architecture also enables improved usability by reducing the time the user waits to receive the desired information or content. A preemptive event is communicated before the user actually completes the interaction with a document element. This further has the effect of improved user efficiency since less time is wasted by the user waiting for results to be presented to the user.

Reference is now made to the drawings, wherein like reference numerals are used to refer to like elements throughout. In the following description, for purposes of explanation, numerous specific details are set forth in order to provide a thorough understanding thereof. It may be evident, however, that the novel implementations can be practiced without these specific details. In other instances, well-known structures and devices are shown in block diagram form in order to facilitate a description thereof. The intention is to cover all modifications, equivalents, and alternatives falling within the spirit and scope of the claimed subject matter.

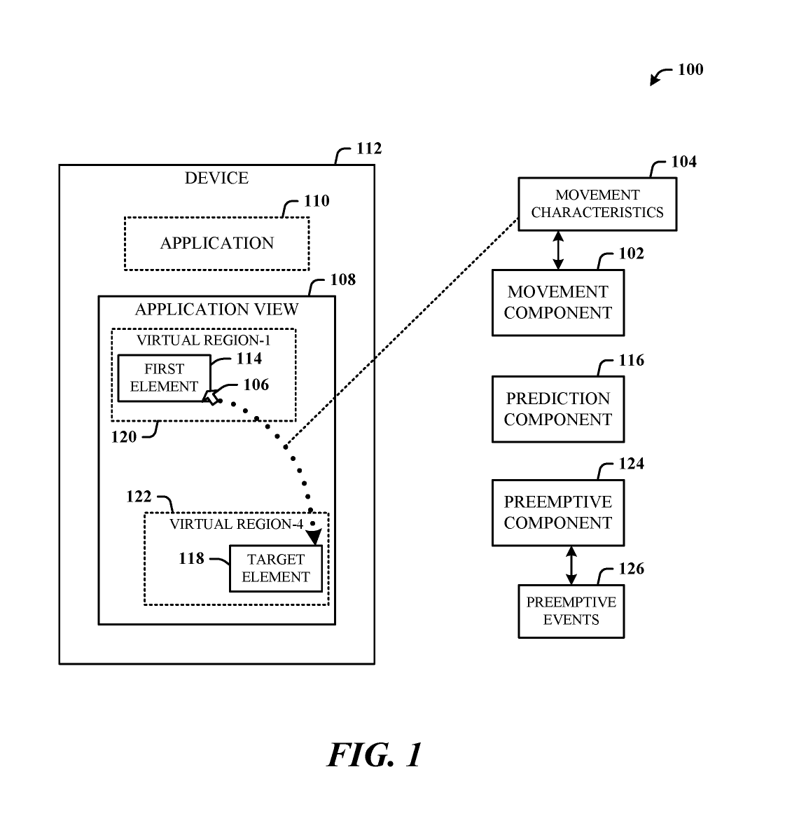

FIG. 1 illustrates a system 100 in accordance with the disclosed architecture. The system 100 can include a movement component 102 provided and configured to compute movement characteristics 104 of a virtual pointer 106 in an application view 108 of an application 110 of a device 112. The device 112 can be a desktop computer, portable computing device, handheld device (e.g., tablet, cell phone, etc.), and any other types of computing devices. The movement characteristics 104 of the virtual pointer 106 are computed from a first element 114 in the application view 108.

A prediction component 116 is provided and configured to predict an intended target element 118 based on machine learning as applied to the movement characteristics 104 of the virtual pointer 106 in virtual regions (e.g., a virtual region 120 and a virtual region 122) of the application view 108. The prediction component 116 can be configured to identify the virtual region 122 of the application view 108 in which the intended target element 118 resides. The virtual region 122 is identified based on the movement characteristics 104 of the virtual pointer 106 in that virtual region 122.

A preemptive component 124 is provided and configured to initiate preemptive events 126 in response to identification of the target element 118 and in anticipation of user interaction with the target element 118 via the virtual pointer 106. The one or more of the preemptive events 126 can be initiated to cause precaching of a backend resource related to the target element 118. The preemptive component 124 is configured to initiate a preemptive event, which causes signaling of a system to precache a request expected from the application when the target element is activated. The initiation of the preemptive event triggers the system to perform an expensive operation (e.g., the most time-expensive operation) identified before the request is received from the application.

The preemptive component is configured to initiate a preemptive event, which causes precaching of a processor-switching context by enabling prefetch of processor registers of a thread expected to be executed.

The prediction component and preemptive component are configured to operate on the movement characteristics of the virtual pointer as relate to movement of the virtual pointer relative to multiple active applications of the device or active applications running on the device and other devices. The prediction component is configured to identify the intended target element based on analysis of historical data from previous user actions with the elements of the application.

At least one hardware processor can be provided and configured to execute computer-executable instructions in a memory, where the instructions executed enable the movement component 102, the prediction component 116, and the preemptive component 124.

It is to be understood that in the disclosed architecture, certain components may be rearranged, restacked (e.g., with respect to memory stacking of an application), combined, omitted, and additional components may be included. Additionally, in some implementations, all or some of the components are present on the client, while in other implementations some components may reside on a server or are provided by a local or remote service.

For example, the movement component 102, prediction component 116, and preemptive component 124 can be incorporated as part of a web server system (e.g., a cloud application server), where the movement characteristics 104 are received from the application 110 and/or other programs of the device 112 as the virtual pointer 106 traverses the application view 108.

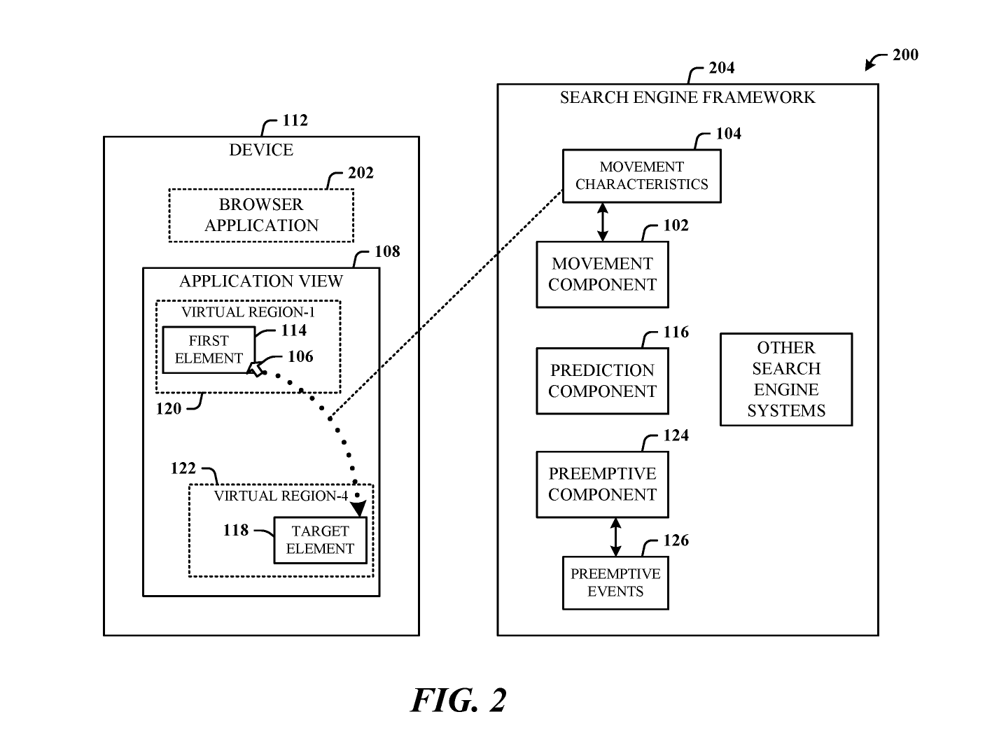

FIG. 2 illustrates an alternative system 200 in accordance with the disclosed architecture, where the application 110 of system 100 is now a browser application 202 (also referred to as a browser), and, the movement component 102, prediction component 116, and preemptive component 124 can be incorporated as part of a search engine framework 204.

Browsers can enable a website to track the movements of a mouse pointer (the virtual pointer or indicator) over its webpages. In one implementation, this can be achieved via an onmousemove event attached to the body HTML (hypertext markup language) tag, as described in an HTML standard. The onmousemove event is triggered by the browser (browser application 202) whenever the mouse pointer changes its X or Y coordinates. The event arguments of the callback function provide the new X and Y coordinates in terms of pixel positions on the device display. Thus, the mouse coordinates can be tracked (e.g., continuously) as a signal that indicates the user's intention(s).

Accordingly, the movement characteristics 104 are received from the browser application 202 of the device 112 as the virtual pointer 106 traverses the application view 108 of the browser application 202.

In a more specific implementation, code (e.g., scripting code such as JavaScript™) can be attached to the onmousemove event, once the search engine page link is loaded for the user inside the browser application 202. The client side code starts appending X and Y coordinates received from the event callback, to a queue.

A signal processing algorithm (e.g., JavaScript-type) based on a machine learning technique dequeues the mouse pointer coordinates and predicts where the mouse pointer will be. Once the threshold for the preemptive event is met the preemptive event is triggered.

With respect to machine learning, continuous density hidden Markov models (CDHMM) can be employed to predict the target element the user will interact with, by looking at X and Y coordinates. In hidden Markov model terminology, the X and Y coordinates are called “observations”. Different regions on the display can be represented by a multi-variate normal distribution (two-variate, as there is both an X and a Y coordinate) and these are referred to as “states”. The observations are then decoded into states with a Viterbi algorithm into the Viterbi path. A Forward-Backward algorithm can be utilized to predict the “next” states given the previously decoded states.

The next states in this case are exactly the regions on the display where the mouse (pointer) will move next. If the pointer does not leave its region within a predetermined number of consecutive states (e.g., two), it can then be assumed that that region is the final destination of the pointer. Identifying the target element (e.g., HTML) of that region then becomes trivial. Based on the regions, the algorithm can infer the target (HTML) element the user will likely interact with next, as soon as the user started moving the pointer toward the desired element.

From previously trained data, the likelihood of an event to happen to each element on the document (e.g., webpage) can be inferred. For example, if a certain element does not respond to a “hover” event (the pointer is positioned within a certain area of or over any part of the element) and only responds to a “click”, then the only way for the user to interact with that element is by clicking on it. In this case, it can be inferred that once the target element is predicted via a preemptive event, the user is highly likely going to click on the element (rather than simply hovering over the element).

Knowing in advance and with a high likelihood what the user will soon be doing (e.g., clicking on a link) the code can signal the system (e.g., backend) to precache a request that will soon be arriving to that system (i.e., once the user has actually clicked on the link). This protocol is used to give the backend a “heads-up” in time. Thus, in one implementation, the system can run an operation that takes the greatest amount of time, referred to as the “most time-expensive operation” (e.g., in a search engine, a most time-expensive operation can be the operation that calls an index serve service and runs one or more rankers, for example, so that web results are ready to be displayed to the user immediately). The most time-expensive operation of a system can be determined by performing critical path analysis of executions for a given operation. Thus, in one implementation, the operation that takes the greatest amount of time to complete can be identified and the heads-up notification (trigger) of this operation is used to precache responses from components that are part of the critical path of the system.

In an alternative implementation, a time-expensive operation can be an operation that takes an amount of time to complete relative to (e.g., less than, equal to, greater than, equal to and greater than) a threshold amount of time (e.g., measured in fractions of a second such as more than 100 milliseconds). Alternatively, the threshold can be determined as a percentage. That is, if the time of execution of an operation exceeds ninety percent of the overall set of critical path operations, it is considered a most time-expensive operation and selected for execution over the other operations.

Note that the time-expensive operation need not necessarily be the most time-expensive operation, but can be identified, and the heads-up notification (trigger) of this time-threshold-based operation is used to precache responses from components that are part of the critical path of the system.

When the user clicks on the desired link (referred to as a target link) and a normal request is initiated against the system, by the time the request associated with selecting the target link reaches the backend, the results of the operation have already been cached for this upcoming request. This means that the system is now able to return results to the user much faster (e.g., in terms of seconds or fractions thereof).

The implementation of machine learning algorithms in the code (e.g., JavaScript) works in realtime, such as the continuous density hidden Markov models. The architecture provides an intelligent way to speed-up any website and improves the user experience and vendor returns.

While the “click” interaction is still a widely used user interaction event, the disclosed architecture can also be applied to scroll events by predicting the movements of the pointer as the pointer approaches the right-hand side of the window (where the scrollbar is typically located). Additionally, the disclosed architecture can also be applied to predicting the movements of swipe events by using touch position and pressure points to predict a swipe even before the user has lifted a finger (or fingers) off the touch-based screen. This approach can be further augmented with considerations that in order to have a swipe the user has to touch the screen first (touch event) and then make the swipe movement.

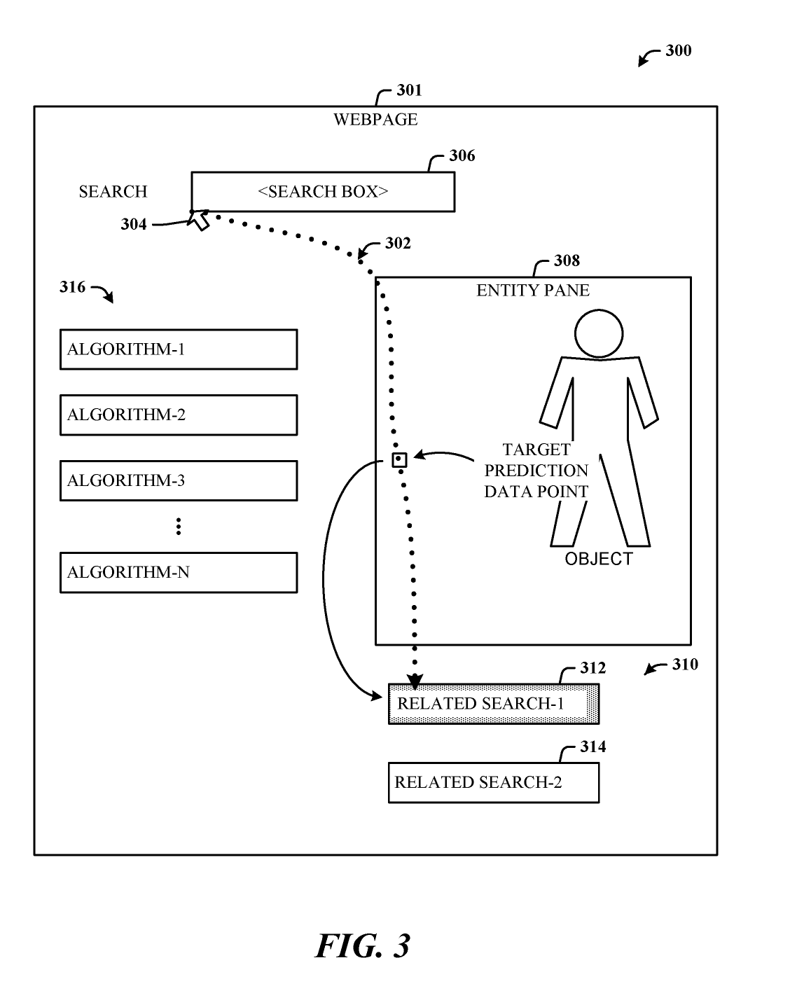

FIG. 3 illustrates a diagram 300 of target element prediction on a webpage 301 in accordance with the disclosed architecture. In one implementation, the disclosed architecture predicts the target element as X and Y coordinates. The movement characteristics can include not only the pointer (previous) coordinates, but other metrics such as the delay between the one or more coordinate points, which delay enables at least the computation of acceleration and the velocity of the movements as the user moves the pointer.

Here, the path (or trajectory) 302 of a pointer 304 is shown as a dotted line that begins at a location proximate a search box 306 (e.g., after the user enters a search query in the search box 306) and extends across an entity pane 308 in the direction of related search elements 310 (e.g., a Related Search-1 element 312 and a Related Search-2 element 314). As depicted, each dot in the path 302 can represent an x/y coordinate as enqueued for machine learning processing, and is a target prediction data point. Moreover, the time taken to travel from one dot to another can be used to compute movement characteristics such as not only velocity, but also acceleration and heading.

Using the movement characteristics, velocity can be computed. Tracking velocity, for example, enables differentiating whether the user will likely terminate the pointer 304 on Related Search-1 element 312 or Related Search-2 element 314, since it might be the case that the coordinate pattern (or distribution along the path 302) is the same, but not the velocity of the pointer 304, since the user would have to stop earlier to terminate on Related Search-1 block 312.

Using Newton's First Law of Motion (i.e., inertia, where the tendency of objects in motion is to stay in motion), the pointer 304 is a moving object which has inertia (via the user's hand or other gesture type). To slow (or stop) the movement of the pointer 304 towards (on) an element, the user has to apply force on the pointer 304, which leaves a trail of information that can be used to account for choosing the Related Search-1 element 312 or Related Search-2 element 314. Here, based on analysis of the movement characteristics, the target element is computed to be the Related Search-1 element 312. Accordingly, the preemptive event associated with the Related Search-1 element 312 can be to send a request to return the search results for the Related Search-1 element 312 before the request is actually initiated by the user by way of the user selecting (clicking on) the Related Search-1 element 312.

As depicted, other elements on the webpage 301 can include links to algorithms 316, for example, or any other types of links desired to be made accessible of the user of the webpage.

Included herein is a set of flowcharts representative of exemplary methodologies for performing novel aspects of the disclosed architecture. While, for purposes of simplicity of explanation, the one or more methodologies shown herein, for example, in the form of a flowchart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

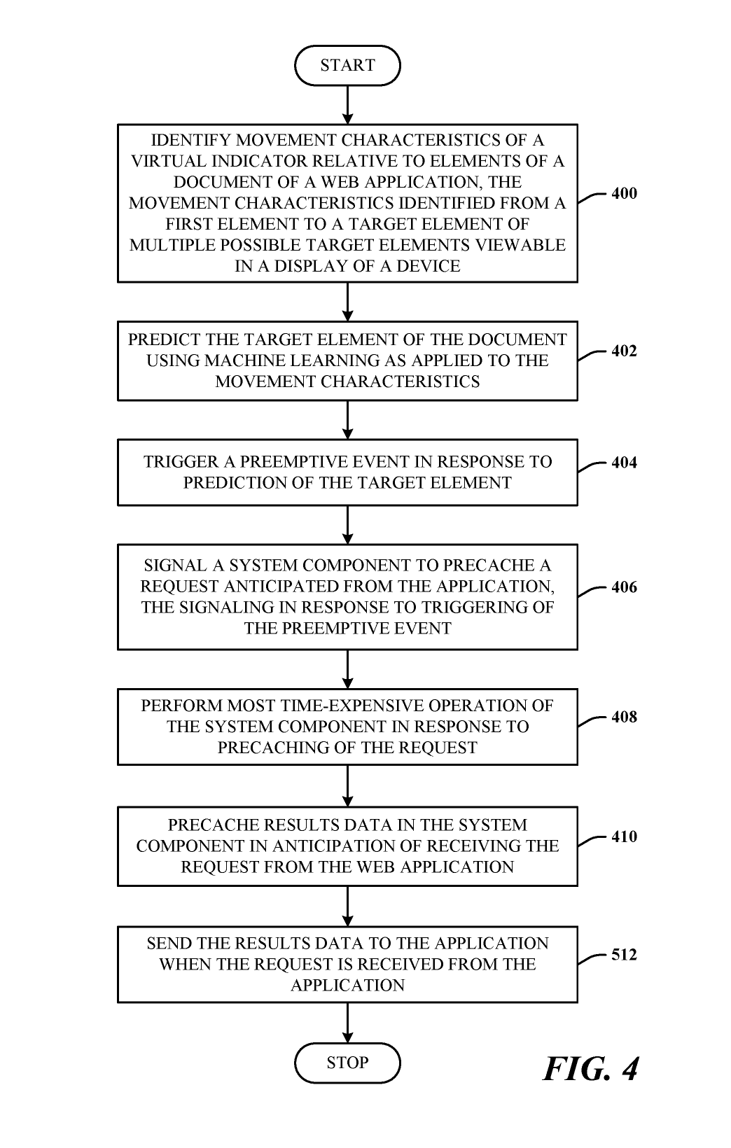

FIG. 4 illustrates a method in accordance with the disclosed architecture. The method can be realized as a computer-implemented method comprising computer-executable instructions that when executed by a hardware processor, perform the following acts. At 400, movement characteristics of a virtual indicator relative to elements of a document of a web application, are identified. The movement characteristics are identified from a first element to a target element of multiple possible target elements viewable in a display of a device. At 402, the target element of the document is predicted using machine learning as applied to the movement characteristics.

At 404, a preemptive event is triggered in response to prediction of the target element. At 406, a system component is signaled to precache a request anticipated from the application, the signaling in response to triggering of the preemptive event. At 408, a most time-expensive operation of the system component that requires a greatest amount of time to execute is performed in response to precaching of the request. At 410, results data is precached in the system component in anticipation of receiving the request from the web application. At 412, the results data are sent to the application when the request is received from the application.

The method can further comprise employing machine learning to predict the target element based on the movement characteristics of the virtual indicator. The method can further comprise predicting the target element based in part on a virtual region of the display in which the target element is located.

The method can further comprise precaching at least one of local resources for the device or external resources of a backend system in response to the preemptive event. The method can further comprise predicting the target element via the web application, which is a browser application, where the target element is a hypertext markup language (HTML) element.

The method can further comprise predicting touch-based preemptive events on the device, which is a touch-enabled device, based on touch contact points of the device. The method can further comprise predicting the target element based on movement characteristics that include at least one of trajectory, velocity, acceleration, dwell, user intent, or delay of the virtual indicator.

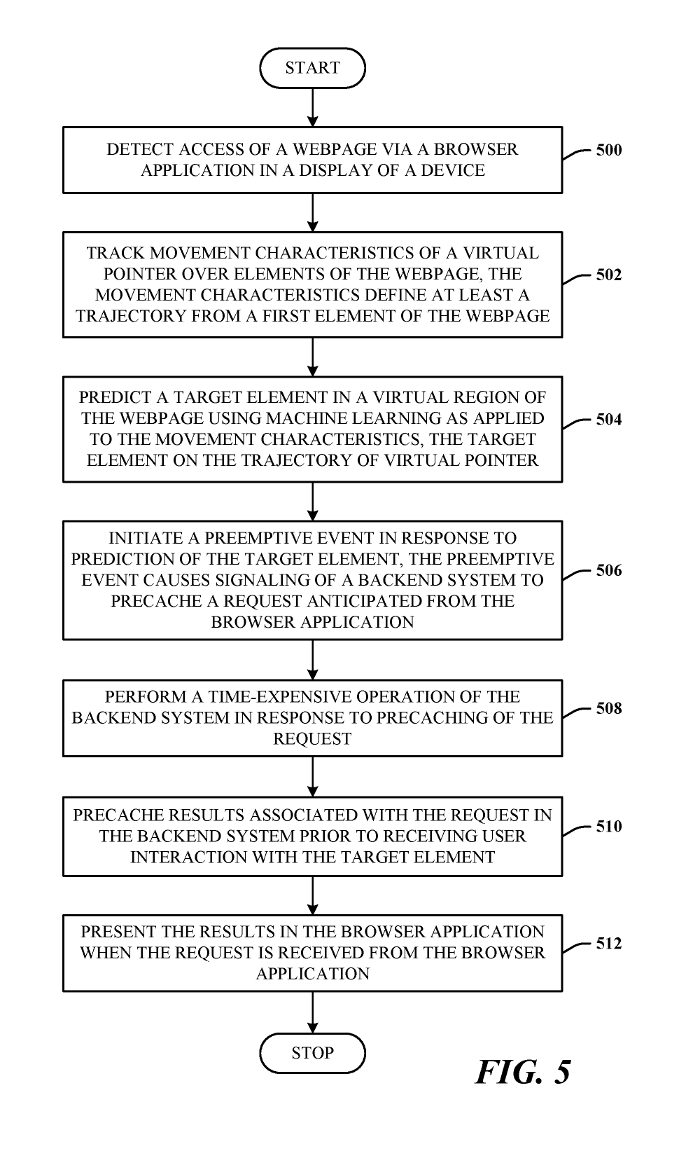

FIG. 5 illustrates an alternative method in accordance with the disclosed architecture. The alternative method can be realized as a computer-implemented method comprising computer-executable instructions that when executed by a hardware processor, perform the following acts. At 500, access of a webpage is detected via a browser application in a display of a device. At 502, movement characteristics of a virtual pointer are tracked over elements of the webpage. The movement characteristics define at least a trajectory from a first element of the webpage.

At 504, a target element in a virtual region of the webpage is predicted using machine learning as applied to the movement characteristics. The target element can be on the trajectory of the virtual pointer. At 506, a preemptive event is initiated in response to prediction of the target element, the preemptive event causes signaling of a backend system to precache a request anticipated from the browser application.

At 508, a time-expensive operation of the backend system is performed in response to precaching of the request. The most time-expensive operation is the operation, among multiple operations along a critical path of computation, that requires the greatest amount of time to execute. The time expense can be computed relative to one or more other operations, or measured against (e.g., exceed) a predetermined time threshold.

At 510, results associated with the request are precached in the backend system prior to receiving user interaction with the target element. At 512, the results are presented in the browser application when the request is received from the browser application.

The method can further comprise acts of: loading the target element, which is a search engine link, into the browser application; responsive to the loading of the target element, attaching script code to a browser event; and, storing movement characteristics information of the virtual pointer using the scripting code.

The method can further comprise acts of: characterizing the display into virtual regions; and, predicting a next virtual region into which the virtual pointer will move. The method can further comprise computing likelihood data, for each element of the webpage, that a preemptive event of a corresponding element will be initiated. The method can further comprise identifying the target element based on movement characteristics of the virtual pointer in the virtual region of the target element.

As used in this application, the term “component” is intended to refer to a computer-related entity, either hardware, a combination of software and tangible hardware, software, or software in execution. For example, a component can be, but is not limited to, tangible components such as one or more microprocessors, chip memory, mass storage devices (e.g., optical drives, solid state drives, magnetic storage media drives, etc.), computers, and portable computing and computing-capable devices (e.g., cell phones, tablets, smart phones, etc.). Software components include processes running on a microprocessor, an object (a software entity that maintains state in variables and behavior using methods), an executable, a data structure (stored in a volatile or a non-volatile storage medium), a module (a part of a program), a thread of execution (the smallest sequence of instructions that can be managed independently), and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

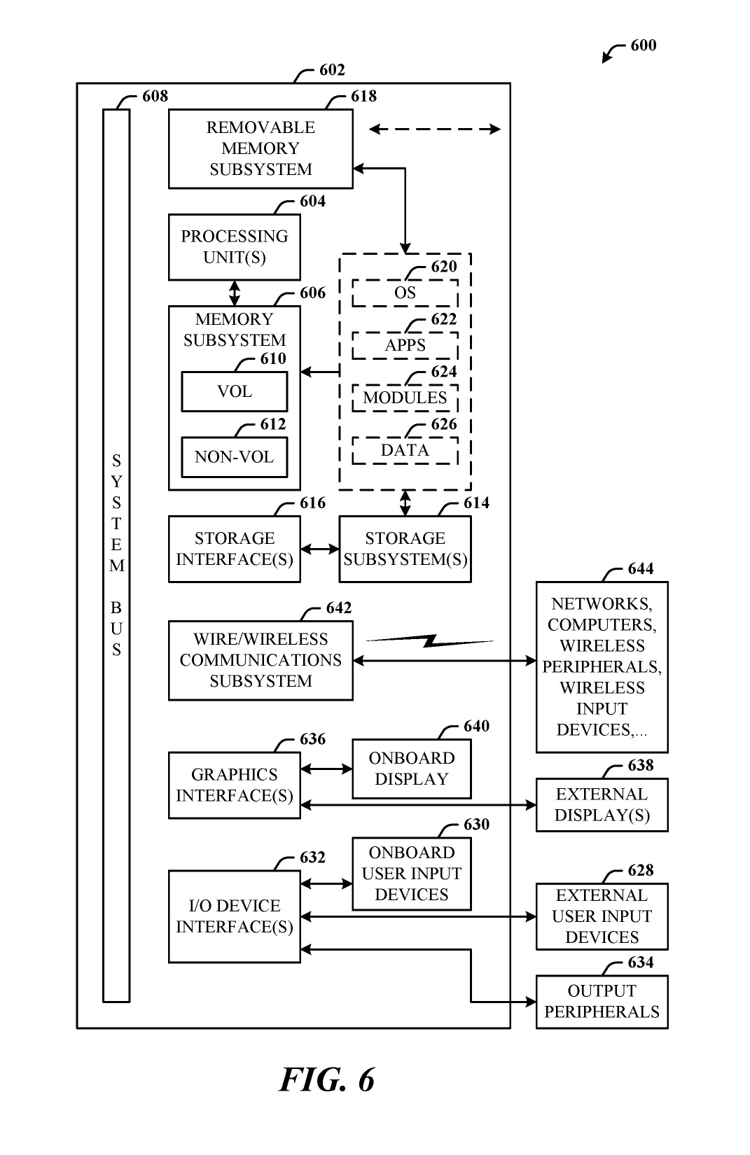

Referring now to FIG. 6, there is illustrated a block diagram of a computing system 600 that executes precaching via input method trajectory prediction in accordance with the disclosed architecture. Alternatively, or in addition, the functionally described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc., where analog, digital, and/or mixed signals and other functionality can be implemented in a substrate.

In order to provide additional context for various aspects thereof, FIG. 6 and the following description are intended to provide a brief, general description of the suitable computing system 600 in which the various aspects can be implemented. While the description above is in the general context of computer-executable instructions that can run on one or more computers, those skilled in the art will recognize that a novel implementation also can be realized in combination with other program modules and/or as a combination of hardware and software.

The computing system 600 for implementing various aspects includes the computer 602 having microprocessing unit(s) 604 (also referred to as microprocessor(s) and processor(s)), a computer-readable storage medium (where the medium is any physical device or material on which data can be electronically and/or optically stored and retrieved) such as a system memory 606 (computer readable storage medium/media also include magnetic disks, optical disks, solid state drives, external memory systems, and flash memory drives), and a system bus 608. The microprocessing unit(s) 604 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 602 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 606 can include computer-readable storage (physical storage) medium such as a volatile (VOL) memory 610 (e.g., random access memory (RAM)) and a non-volatile memory (NON-VOL) 612 (e.g., ROM, EPROM, EEPROM, etc.). A basic input/output system (BIOS) can be stored in the non-volatile memory 612, and includes the basic routines that facilitate the communication of data and signals between components within the computer 602, such as during startup. The volatile memory 610 can also include a high-speed RAM such as static RAM for caching data.

The system bus 608 provides an interface for system components including, but not limited to, the system memory 606 to the microprocessing unit(s) 604. The system bus 608 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 602 further includes machine readable storage subsystem(s) 614 and storage interface(s) 616 for interfacing the storage subsystem(s) 614 to the system bus 608 and other desired computer components and circuits. The storage subsystem(s) 614 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 616 can include interface technologies such as EIDE, ATA, SATA, and IEEE 1394, for example.

One or more programs and data can be stored in the memory subsystem 606, a machine readable and removable memory subsystem 618 (e.g., flash drive form factor technology), and/or the storage subsystem(s) 614 (e.g., optical, magnetic, solid state), including an operating system 620, one or more application programs 622, other program modules 624, and program data 626.

The operating system 620, one or more application programs 622, other program modules 624, and/or program data 626 can include items and components of the system 100 of FIG. 1, items and components of the system 200 of FIG. 2, items and elements the diagram 300 of FIG. 3, and the methods represented by the flowcharts of FIGS. 4 and 5, for example.

Generally, programs include routines, methods, data structures, other software components, etc., that perform particular tasks, functions, or implement particular abstract data types. All or portions of the operating system 620, applications 622, modules 624, and/or data 626 can also be cached in memory such as the volatile memory 610 and/or non-volatile memory, for example. It is to be appreciated that the disclosed architecture can be implemented with various commercially available operating systems or combinations of operating systems (e.g., as virtual machines).

The storage subsystem(s) 614 and memory subsystems (606 and 618) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data that cause a general purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 602, and include volatile and non-volatile internal and/or external media that is removable and/or non-removable. For the computer 602, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 602, programs, and data using external user input devices 628 such as a keyboard and a mouse, as well as by voice commands facilitated by speech recognition. Other external user input devices 628 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 602, programs, and data using onboard user input devices 630 such a touchpad, microphone, keyboard, etc., where the computer 602 is a portable computer, for example.

These and other input devices are connected to the microprocessing unit(s) 604 through input/output (I/O) device interface(s) 632 via the system bus 608, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 632 also facilitate the use of output peripherals 634 such as printers, audio devices, camera devices, and so on, such as a sound card and/or onboard audio processing capability.

One or more graphics interface(s) 636 (also commonly referred to as a graphics processing unit (GPU)) provide graphics and video signals between the computer 602 and external display(s) 638 (e.g., LCD, plasma) and/or onboard displays 640 (e.g., for portable computer). The graphics interface(s) 636 can also be manufactured as part of the computer system board.

The computer 602 can operate in a networked environment (e.g., IP-based) using logical connections via a wired/wireless communications subsystem 642 to one or more networks and/or other computers. The other computers can include workstations, servers, routers, personal computers, microprocessor-based entertainment appliances, peer devices or other common network nodes, and typically include many or all of the elements described relative to the computer 602. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 602 connects to the network via a wired/wireless communication subsystem 642 (e.g., a network interface adapter, onboard transceiver subsystem, etc.) to communicate with wired/wireless networks, wired/wireless printers, wired/wireless input devices 644, and so on. The computer 602 can include a modem or other means for establishing communications over the network. In a networked environment, programs and data relative to the computer 602 can be stored in the remote memory/storage device, as is associated with a distributed system. It will be appreciated that the network connections shown are exemplary and other means of establishing a communications link between the computers can be used.

The computer 602 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

The disclosed architecture can be implemented as a system, comprising: means for detecting access of a webpage via a browser application in a display of a device; means for tracking movement characteristics of a virtual pointer over elements of the webpage, the movement characteristics define at least a trajectory from a first element of the webpage; means for predicting a target element in a virtual region of the webpage using machine learning as applied to the movement characteristics, the target element on the trajectory of the virtual pointer; means for initiating a preemptive event in response to prediction of the target element, the preemptive event causes signaling of a backend system to precache a request anticipated from the browser application; means for performing a time-expensive operation of the backend system in response to precaching of the request; means for precaching results associated with the request in the backend system prior to receiving user interaction with the target element; and, means for presenting the results in the browser application when the request is received from the browser application.

The disclosed architecture can be implemented as an alternative system, comprising: means for identifying movement characteristics of a virtual indicator relative to elements of a document of a web application, the movement characteristics identified from a first element to a target element of multiple possible target elements viewable in a display of a device; means for predicting the target element of the document using machine learning as applied to the movement characteristics; means for triggering a preemptive event in response to prediction of the target element; means for signaling a system component to precache a request anticipated from the application, the signaling in response to triggering of the preemptive event; means for performing a time-expensive operation of the system component in response to precaching of the request; means for precaching results data in the system component in anticipation of receiving the request from the web application; and, means for sending the results data to the application when the request is received from the application.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a movement component configured to compute movement characteristics of a virtual pointer in an application view of an application of a device, the movement characteristics of the virtual pointer computed from a first element in the application view;
a prediction component configured to predict an intended target element based on machine learning as applied to the movement characteristics of the virtual pointer in virtual regions of the application view;
a preemptive component configured to initiate preemptive events in response to identification of the target element and in anticipation of user interaction with the target element via the virtual pointer; and
at least one hardware processor configured to execute computer-executable instructions in a memory, the instructions executed to enable at least the movement component, the prediction component, and the preemptive component.

2. The system of claim 1, wherein the preemptive events initiated cause precaching of a backend resource related to the target element.

3. The system of claim 1, wherein the prediction component is configured to identify a virtual region of the application view in which the intended target element resides, the virtual region identified based the movement characteristics of the virtual pointer in that virtual region.

4. The system of claim 1, wherein the preemptive component is configured to initiate a preemptive event that causes signaling of a system to precache a request expected from the application when the target element is activated.

5. The system of claim 4, wherein the initiation of the preemptive event triggers the system to perform a most time-expensive operation identified before the request is received from the application.

6. The system of claim 1, wherein the preemptive component is configured to initiate a preemptive event which causes precaching of a processor switching context by enabling prefetch of processor registers of a thread expected to be executed.

7. The system of claim 1, wherein the prediction component and preemptive component are configured to operate on the movement characteristics of the virtual pointer relative to multiple active applications of the device or active applications running on the device and other devices.

8. The system of claim 1, wherein the prediction component is configured to identify the intended target element based on analysis of historical data from previous user actions with the elements of the application.

9. A computer-implemented method comprising computer-executable instructions that when executed by a hardware processor, perform acts of:
identifying movement characteristics of a virtual indicator relative to elements of a document of a web application, the movement characteristics identified from a first element to a target element of multiple possible target elements viewable in a display of a device;
predicting the target element of the document based on the movement characteristics;
triggering a preemptive event in response to prediction of the target element;
signaling a system component to precache a request anticipated from the application, the signaling in response to triggering of the preemptive event;
performing a most time-expensive operation of the system component in response to precaching of the request;
precaching results data in the system component in anticipation of receiving the request from the web application; and
sending the results data to the application when the request is received from the application.

10. The method of claim 9, further comprising employing machine learning to predict the target element based on the movement characteristics of the virtual indicator.

11. The method of claim 9, further comprising predicting the target element based in part on a virtual region of the display in which the target element is located.

12. The method of claim 9, further comprising precaching at least one of local resources for the device or external resources of a backend system in response to the preemptive event.

13. The method of claim 9, further comprising predicting the target element via the web application, which is a browser application, where the target element is a hypertext markup language element.

14. The method of claim 9, further comprising predicting touch-based preemptive events on the device, which is a touch-enabled device, based on touch contact points of the device.

15. The method of claim 9, further comprising predicting the target element based on movement characteristics that include at least one of trajectory, velocity, acceleration, dwell, user intent, or delay of the virtual indicator.

16. A computer-implemented method comprising computer-executable instructions that when executed by a hardware processor, perform acts of:
detecting access of a webpage via a browser application in a display of a device;
tracking movement characteristics of a virtual pointer over elements of the webpage, the movement characteristics define at least a trajectory from a first element of the webpage;
predicting a target element in a virtual region of the webpage using machine learning as applied to the movement characteristics, the target element on the trajectory of the virtual pointer;
initiating a preemptive event in response to prediction of the target element, the preemptive event causes signaling of a backend system to precache a request anticipated from the browser application;
performing a time-expensive operation of the backend system in response to precaching of the request;
precaching results associated with the request in the backend system prior to receiving user interaction with the target element; and
presenting the results in the browser application when the request is received from the browser application.

17. The method of claim 16, further comprising acts of:
loading the target element, which is a search engine link, into the browser application;
responsive to the loading of the target element, attaching script code to a browser event; and
storing movement characteristics information of the virtual pointer using the scripting code.

18. The method of claim 16, further comprising:
characterizing the display into virtual regions; and
predicting a next virtual region into which the virtual pointer will move.

19. The method of claim 16, further comprising computing likelihood data, for each element of the webpage, that a preemptive event of a corresponding element will be initiated.

20. The method of claim 16, further comprising identifying the target element based on movement characteristics of the virtual pointer in the virtual region of the target element.
